(19) United States
(12) Patent Application Publication
(10) Pub. No.: US 2013/0067212 A1
(43) Pub. Date: Mar. 14, 2013

(54) SECURING IMPLEMENTATION OF CRYPTOGRAPHIC ALGORITHMS USING ADDITIONAL ROUNDS

(71) Applicants: Augustin J. FARRUGIA, Cupertino, CA (US); Benoit CHEVALLIER-MAMES, Paris (FR); Bruno KINDARJI, Paris (FR); Mathieu CIET, Paris (FR); Thomas ICART, Paris (FR)

(72) Inventors: Augustin J. FARRUGIA, Cupertino, CA (US); Benoit CHEVALLIER-MAMES, Paris (FR); Bruno KINDARJI, Paris (FR); Mathieu CIET, Paris (FR); Thomas ICART, Paris (FR)

(21) Appl. No.: 13/232,853

(22) Filed: Sep. 14, 2011

(51) Int. Cl. H04L 9/00

(52) U.S. Cl. 713/150

(57) ABSTRACT

In the field of computer enabled cryptography, such as a keyed block cipher having a plurality of sequenced rounds, the cipher is hardened against an attack by a protection process which adds rounds to the cipher process. This is especially advantageous in a “White Box” environment where an attacker has full access to the cipher algorithm (process), including the algorithm's internal state during its execution. In one version, a specific number of rounds are added over those of a standard version of the cipher to both encryption and the complementary decryption. The added rounds are inserted immediately after the last of the standard rounds in the sequence. In another version, the added rounds are one or more opposing paired rounds of encryption/decryption or decryption/encryption which effectively cancel each other out, and may be inserted anywhere in the sequence of standard rounds.

### FIELD OF THE INVENTION

This invention relates to data security, cryptography and cipher protection.

### BACKGROUND

In the field of data security, there is a need for fast and secure encryption. This is why the AES (Advanced Encryption Standard) cipher has been designed and standardized to replace the DES (Data Encryption Standard) cipher. Cryptographic algorithms are widely used for encryption and decryption of messages, authentication, digital signatures and identification. AES is a well known symmetric block cipher. Block ciphers operate on blocks of plaintext and ciphertext, usually of 64 or 128 bits length but sometimes longer. Stream ciphers are the other main type of cipher and operate on streams of plain text and cipher text 1 bit or byte (sometimes one word) at a time. There are modes of operation (notably the ECB, electronic code block) where a given block is encrypted to always the same ciphertext block. This is an issue which is solved by a more evolved mode of operations, e.g. CBC (cipher block chaining) where a chaining value is used to solve the 1-to-1 map.

AES is approved as an encryption standard by the U.S. Government. Unlike its predecessor DES (Data Encryption Standard), it is a substitution permutation network (SPN). AES is fast to execute in both computer software and hardware implementation, relatively easy to implement, and requires little memory. AES has a fixed block size of 128 bits and a key size of 128, 192 or 256 bits. Due to the fixed block size of 128 bits, AES operates on a 4×4 array of bytes. It uses key expansion and like most block ciphers a set of encryption and decryption rounds (iterations). Block ciphers of this type include in each round use of substitution boxes (S-boxes). This operation provides non-linearity in the cipher and significantly enhances security.

Note that these block ciphers are symmetric ciphers, meaning the same key is used for encryption and decryption. As is typical in most modern ciphers, security rests with the (secret) key rather than the algorithm. The S-boxes accept an n-bit input and provide an m-bit output. The values of m and n vary with the cipher and the S-box itself. The input bits specify an entry in the S-box in a particular manner well known in the field.

Many encryption algorithms are primarily concerned with producing encrypted data that is resistant to decrypting by an attacker who can interact with the encryption algorithm only as a “Black Box” (input-output) model, and cannot observe internal workings of the algorithm or memory contents, etc. due to lack of system access. The Black Box model is appropriate for applications where trusted parties control the computing systems for both encoding and decoding ciphered materials.

However, many applications of encryption do not allow for the assumption that an attacker cannot access internal workings of the algorithm. For example, encrypted digital media often needs to be decrypted on computing systems that are completely controlled by an adversary (attacker). There are many degrees to which the Black Box model can be relaxed. An extreme relaxation is called the “White Box” model. In a White Box model, it is presumed that an attacker has total access to the system performing an encryption (or decryption), including being able to observe directly a state of memory, program execution, modifying an execution, etc. In such a model, an encryption key can be observed in or extracted from memory, and so ways to conceal operations indicative of a secret key are important.

Classically, software implementations of cryptographic building blocks are insecure in the White Box threat model where the attacker controls the execution process. The attacker can easily lift the secret key from memory by just observing the operations acting on the secret key. For example, the attacker can learn the secret key of an AES software implementation by observing the execution of the key schedule algorithm.

Hence there are two basic principles in the implementation of secure computer applications (software). The Black Box model implicitly supposes that the user does not have access to the computer code nor any cryptographic keys themselves. The computer code security is based on the tampering resistance over which the application is running, as this is typically the case with SmartCards. For the White Box model, it is assumed the (hostile) user has partially or fully access to the implemented code algorithms; including the cryptographic keys themselves. It is assumed the user can also become an attacker and can try to modify or duplicate the code since he has full access to it in a binary (object code) form. The White Box implementations are widely used (in particular) in content protection applications to protect e.g. audio and video content.

Straightforward software implementations of cryptographic building blocks are insecure in the White Box threat model where the attacker controls the computer execution process. The attacker can easily extract the (secret) key from the memory by just observing the operations acting on the secret key. For instance, the attacker can learn the secret key of an AES cipher software implementation by passively monitoring the execution of the key schedule algorithm. Also, the attacker could be able to retrieve partial cryptographic result and use it in another context (using in a standalone code, or injecting it in another program, as an example).

Content protection applications such as for audio and video data are one instance where it is desired to keep the attacker from finding the secret key even though the attacker has complete control of the execution process. The publication “White-Box Cryptography in an AES implementation” Lecture Notes in Computer Science Vol. 2595, Revised Papers from the 9th Annual International Workshop on Selected Areas in Cryptography pp. 250-270 (2002) by Chow et al. discloses implementations of AES that obscure the operations performed during AES by using table lookups (also referred to as TLUs) to obscure the secret key within the table lookups, and obscure intermediate state information that would otherwise be available in arithmetic implementations of AES. In the computer field, a table lookup is an operation consisting of looking in a table (also called an array) at a given index position in the table.

Chow et al. (for his White Box implementation where the key is known at the computer code compilation time) uses 160 separate tables to implement the 11 AddRoundKey operations and 10 SubByte Operations (10 rounds, with 16 tables per round, where each table is for 1 byte of the 16 byte long—128 bit—AES block). These 160 tables embed a particular AES key, such that output from lookups involving these tables embeds data that would normally result from the AddRoundKey and SubByte operations of the AES algorithm, except that this data includes input/output permutations that make it more difficult to determine what parts of these tables represent round key information derived from the AES key. Chow et al. provide a construction of the AES algorithm for such White Box model. The security of this construction resides in the use of table lookups and permutations supplied on the input and output of table lookups. The input and output mask applied to this data is never removed along the process. In this solution, there is a need for knowing the key value at the compilation time, or at least to be able to derive the tables from the original key in a secure environment or in a secure way.

The conventional implementation of a block cipher in the White Box model is carried out by creating a set of table lookups. Given a dedicated cipher key, the goal is to store in a table the results for all the possible input messages. This principle is applied for each basic operation of the block cipher. In the case of the AES cipher, these are the shiftRow, the add RoundKey, the subByte and the mixColumns operations.

However, Chow et al. do not solve all the security needs for block cipher encryption in a White Box environment. Indeed, the case where the cipher key is derived through a given process and so is unknown at the code compilation time is not addressed by Chow et al. Further, the publication “Cryptanalysis of a White Box AES Implementation” by Olivier Billet et al., in “Selected Areas in Cryptography 2004” (SAC 2004), pages 227-240 is an efficient attack on a White Box cipher of the type described by Chow et al., indicating weaknesses in Chow et al.'s approach. Software implementations of cryptographic building blocks are thus insecure in the White Box threat model where the attacker controls the execution process. The attacker can easily lift the secret key from memory by just observing the operations acting on the secret key. For example, the attacker can learn the secret key of an AES software implementation by observing the execution of the key schedule algorithm.

However, this solution does not solve all needs for block cipher security. Indeed, an analysis of the cipher execution reveals which sections of the associated computer code are critical and enables an attacker to study the cryptographic process. With a simple section of executable binary (object code) of the cipher, it is possible to attack the static White Box AES cipher.

### SUMMARY

For those cases when the cipher key is unknown at the compilation time or when the code size is limited, there is a need to harden “dynamically” the process and hide the key. This is the subject of the present disclosure that can be combined with existing solutions. This disclosure is of methods to make the cipher process execution dynamically different.

This disclosure is of ways to make execution of a decryption or encryption process opaque. The first method provides additional cipher rounds during encryption, that are later removed during decryption, or additional rounds added during decryption that are later removed during encryption. While the encryption then decryption is explained in detail below, doing this in the other direction will be apparent to one skilled in the art. The second method provides additional cipher rounds in the execution of the decryption or encryption process. These two processes render the location of the beginning and the ‘end of the decryption or encryption process unclear to an attacker. They also protect cryptographic values that are in a function, since the values cannot be retrieved easily after a simple decryption. This supports integrity verification and cryptographic modes of operation of block ciphers.

### BRIEF DESCRIPTION OF THE FIGURES

FIG. 1 shows, in the prior art, AES encryption.

FIG. 2 shows, in the prior art, cipher block chaining encryption and decryption.

FIG. 3 shows a computing system in accordance with the invention.

FIG. 4 shows a computing system as known in the art and used in accordance with the invention.

### DETAILED DESCRIPTION

### AES Description

See the NIST AES standard for a more detailed description of the AES cipher:

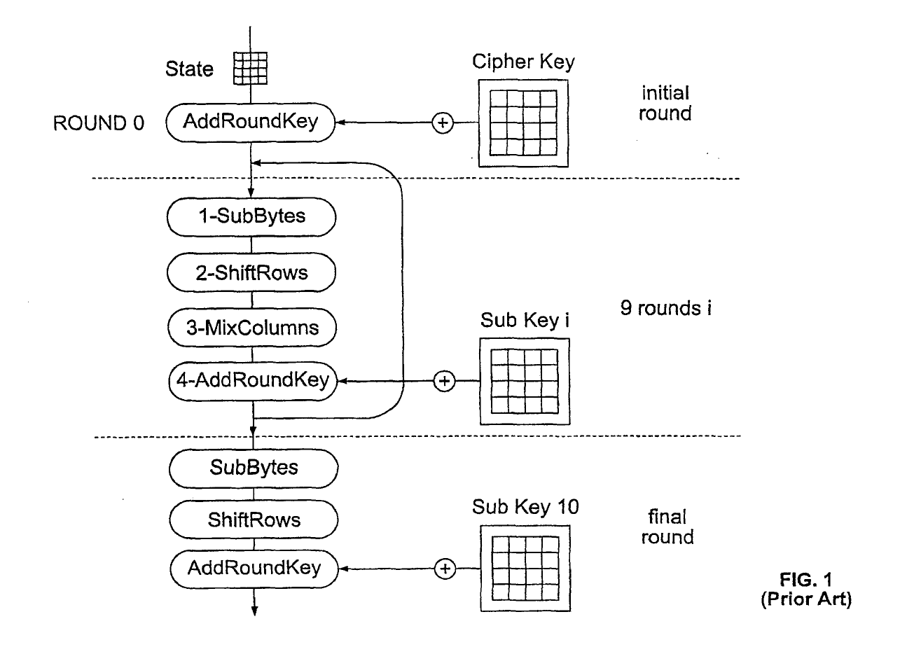

Specification for the ADVANCED ENCRYPTION STANDARD (AES), NIST, http://csrc.nist.gov/publications/fips/fips197/fips-197.pdf. The following is a summary of the well known AES cipher. The AES cipher uses a 16 byte cipher key, and has 10 rounds (final found plus 9 others). The AES encryption algorithm has the following operations as depicted graphically in prior art FIG. 1 and showing round zero and the other 9 rounds:

11 AddRoundKey Operations

10 SubByte Operations

10 ShiftRow Operations

9 MixColumn Operations

AES is computed using a 16-byte buffer (computer memory) referred to as the AES “state” in this disclosure and shown in FIG. 1.

To summarize,
(i) AddRoundKeys (ARK) logically XOR (the Boolean exclusive OR operation) some sub-key bytes with the state bytes.
(ii) ShiftRows (SR) are a move from one byte location to another.
(iii) MixColums (MC) are a linear table-look up (TLU), applied to 4 bytes.
(iv) SubBytes (SB) are a non-linear TLU, applied to 1 byte.

Preliminarily to the encryption itself, in the initial round in FIG. 1, the original 16-byte cipher key is expanded to 11 sub-keys (also called round keys) designated K0, . . . , K10, so there is a sub-key for each round, during what is called the key-schedule. Each sub-key, like the original cipher key, is 16-bytes long.

The following explains AES decryption round by round. For the corresponding encryption (see FIG. 1), one generally performs the inverse of each operation, in the inverse order. (The same is true for the cryptographic processes in accordance with the invention as set forth below.) The inverse operation of ARK is ARK itself, the inverse operation of SB is the inverse subbyte (ISB) which is basically another TLU, the inverse operation of MC is the inverse mix column (IMC) which is basically another TLU, and the inverse operation of SR is the inverse shift row (ISR) which is another move from one byte location to another.

Expressed schematically, AES decryption round-by-round is as follows:

ARK (K10)
ISR
ISB
ARK (K9)
IMC
ISR
ISB
ARK (K8)
IMC
ISR
ISB
ARK (K7)
IMC
ISR
ISB
ARK (K6)
IMC
ISR
ISB
ARK (K5)
IMC
ISR
ISB
ARK (K4)
IMC
ISR
ISB
ARK (K3)
IMC
ISR
ISB
ARK (K2)
IMC
ISR
ISB
ARK (K1)
IMC
ISR
ISB
ARK (K0)

The method in accordance with the invention also can easily be applied to other variants of AES with more rounds (the 192 and 256-bit key length versions even with a 128 bit block size) as well as to other block ciphers and more generally to non-block ciphers and other key based cryptographic processes.

A cryptographic process such as the AES cipher is used to protect a specific piece of information (the “message”). The conventional cryptographic process involved in encryption and decryption is expressed algebraically as:
A secret data (message) designated x is required on a client (in e.g. a client-server system).
A first computing device (the server) generates x, selects a cryptographic key k, and returns Enc(x, k) where Enc (.,.) designates the encryption operation of message x using key k.
A second computing device (the client) receives y=Enc(x, k) and computes x=Dec(y, k) where Dec designates the decryption operation of y associated with Enc again using key k.

The security of this system relies on the fact that an attacker cannot decrypt x from the encrypted value y, without knowledge of the key k. However, if the key k is compromised, then knowing y is enough to recover the secret data x.

This disclosure describes a first embodiment to protect data x so that:
There is protection on the server side removed from the client side.
There is no need for prior knowledge of the key k.
Decrypting the encrypted data using the function Dec and key k does not provide the message (data) x.
Reverse engineering of the decryption process is confusing for the attacker.

In this embodiment, a function designated pre_process(x, k0) is created which is to be executed on the server side, compensated for by a modified decryption function designated Dec′(y, k0, k) to be executed on the client side. This replaces the above conventional (mathematical) identity:

Dec(Enc(x, k) = x, with the updated identity:
Dec′(Enc(pre_process(x, k0), k) = x.

Thereby the implementation of the new decryption function Dec′ is significantly different than the conventional (base0 function Dec. This is done by adding several additional rounds to the base decryption function Dec, which are balanced by the complementary preprocessing of message x which is the input to the encryption function Enc.

In the context of a White Box AES cipher, a classical attack consists of identifying the different rounds of the decryption process, to be able to retrieve the key at a specific memory location. Therefore adding rounds at the beginning, at the end and the middle of the process makes this attack harder. Moreover, adding rounds at the end of the generation and decryption processes forces use of the modified and unusual decryption function Dec′ rather than the conventional and known function Dec, thus enhancing security.

Let Dec designate a standard (conventional) round-based cryptographic process such as the AES decryption explained above having the standard corresponding encryption process designated Enc. A new function which is designated ServerProcess is introduced here. A pseudo code (non-executable depiction of computer source code) of the conventional server side function then is:

### Function ServerProcess (x, k):

return Enc(x, k) where as above x is the message and k the key

A pseudo code implementation of standard decryption of a single block of a message designated y is (where symbol <-- indicates replacement):

Function Dec (y, k):

State <-- y
for (i = 0; i < NUMBER_OF_ROUNDS; i++)
do:

State <-- SingleDecryptionRound(State, k, i)

done
return State

For the end-of-decryption (last) rounds, it is possible to modify the functions ServerProcess and Dec as follows:

Function ServerProcess' (x, k0, k) :

State <− x
for(i= 0; i < R; i++)
do:

State <-- SingleEncRound(State, k0, i)

done
return Enc(State, k)

where R is the number of additional rounds to be executed at decryption and k0 is the new key that does not depend on x, or on the original key k. As explained above, key k0 is applied on input x before the standard cipher key k is applied. Note that key k0 itself can be indexed by the round number. Such a function can be represented as the composition of another function designated Server_Preprocess(x, k0) with the function Enc(x, k):

So to decrypt encrypted message y using key k expressed in pseudo code:

Function Dec′(y, k0, k)

State <− y
total_number_of_rounds <− NUMBER_OF_ROUNDS + R
for (i = 0; i < total_number_of rounds; i++)
do:

if (i < NUMBER_OF_ROUNDS):

State <− SingleDecRound(State, k, i)

else:

State <− SingleDecRound(State, k0, i)

done
Return state

where the variable total_number_of_rounds corresponds to the number of rounds of the conventional (base or standard) cipher plus R.

The combination of ServerProcess′ and Dec′ provides the same result as the standard combination of ServerProcess and Dec, but now two security goals are achieved:

1. Applying Dec on (y, k) does not provide any sensitive information regarding x.

2. The last rounds that are executed do not provide any information on the main key k.

### Cryptographic Modes

For the additional round keys as described above, the use of well known cryptographic chaining modes such as CBC (Cipher Block Chaining), ECB (Electronic Code Book), OFB (Output Feed-Back) and PCBC (Propagating Cipher Block Chaining) make matters somewhat more complex and so the present method is adapted for each such mode. These modes are well known for encryption of large blocks of data. However it is still possible to use this improvement in an even more secure way combined with such cryptographic modes as follows.

The following example is of the chaining for the CBC mode, but this is easily generalized to the other modes by those skilled in the art. Indeed with the present method of adding extra rounds using the CBC mode, the result is incorrect and in case of reports (as in the CBC mode) applying this method directly does not work correctly.

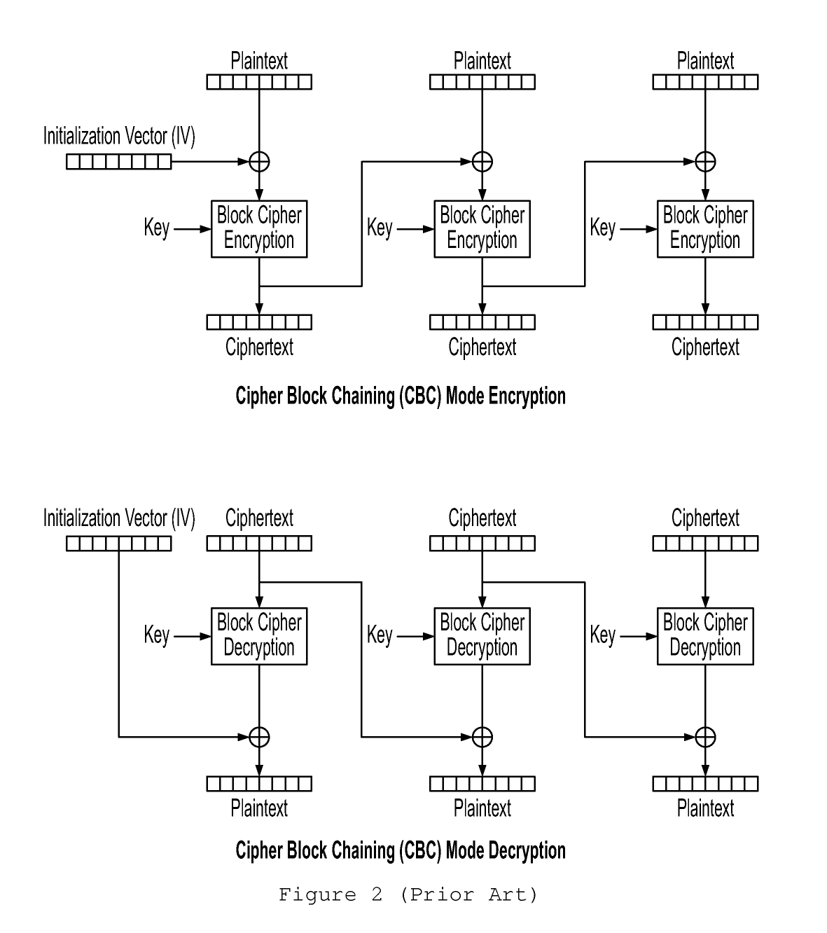

The principle of conventional CBC mode is to make the encryption of one block dependent on the encryption of the previous blocks, which is called chaining. The conventional CBC mode encryption and decryption processes are illustrated graphically in FIG. 2.

This embodiment is of a CBC mode cipher with additional rounds. One replaces the generation process ServerProcess′ described above with a new process designated ServerProcess″ which includes chaining; the decryption process Dec′ is also replaced with a new decryption process designated Dec″.

The generation process ServerProcess″ is that to generate ServerProcess′ (x¹, x^{L}, k0, k), do the following steps:

(1) For each block x^{j}:

add an Initial Value (IV) to x^{j}

Compute R encryption rounds on x^{j} into x^{′j}

Replace the Initial Value (designated IV) with x^{′j}

(2) CBC-encrypt the produced vector x^{′1}, x^{′L}

The decryption process Dec′ then performs two chainings, the first for the conventional (base cipher) decryption rounds, and the second for the additional cipher rounds, as follows expressed in pseudo code:

For each block y^{j}:

Compute the decryption of y^{j} into y^{′j}
Add the decryption IV IV_Dec to y^{′j} then store y^{j} into IV_Dec
Compute R decryption rounds on y^{′j} into y^{”j}
Add the initial value IV
Replace IV with y^{′j}

So as above, the data that is encrypted is modified in order to update the decryption process. In the decryption, one does two chainings instead of one. In the same way that the identities above were verified, another identity expresses this relationship:

Dec′(Enc-CBC(ServerProcess″(x¹, . . . , x^{L}, k0), k), k0, k)=x¹, . . . , x^{L}

Adapting this method to PCBC mode is similar to CBC mode except that the IV (initial value) is replaced by a function of the plaintext and ciphertext at each iteration. So in the same way as described above for two such IVs in CBC mode (with two chaining processes) there are two such IVs in PCBC mode. For the ECB mode, nothing unusual has to be done.

### Adding “Fake” Rounds at the Beginning and the Middle of the Decryption

In round-based encryption processes, the encryption and decryption corresponding rounds SingleDecRound and SingleEncRound are referred to each other's “opposite” rounds. This embodiment uses this “opposing” property. As opposed to the above embodiments, in this embodiment the modification to the conventional decryption process does not require any change to the corresponding encryption process which can remain conventional. This method inserts at several places in the otherwise conventional decryption process a decryption round followed by an opposite encryption round, or an encryption round followed by an opposite decryption round. The round key for each of these added paired rounds is not important since the two paired rounds in effect cancel each other out in terms of the ultimate output state, so any key can be selected for them.

The constraint is that each fake decryption (or encryption) round having the fake key designated fake_key_0 is balanced with a respective fake encryption (or decryption) round with the same fake key fake_key_0. Moreover, this may be done so that all the added rounds look like (are similar to) the original conventional rounds, resulting in the same execution flow to make understanding harder for the attacker.

Any number of such paired opposite rounds can be added, where each additional encryption or decryption round is balanced (compensated for) by its counterpart respective decryption or encryption round. Moreover, the order of encryption and decryption in these fake rounds can be intertwined, as in these non-limiting examples each using two additional pairs:

| | | | |
|---|---|---|---|
| EncRound1 | DecRound1 | EncRound2 | DecRound2 |
| EncRound1 | DecRound1 | DecRound2 | EncRound2 |
| EncRound1 | DecRound2 | EncRound2 | DecRound1 |
| EncRound1 | EncRound2 | DecRound2 | DecRound1. |

Note that there is no limit on the number of these fake rounds.

### Ensuring the Integrity of the Execution

An advantage of the fake rounds is that instead of there being an expected number of rounds as in the AES cipher explained above, the attacker will observe these additional rounds also. So he may be deceived into thinking the cipher is not even AES or a variant thereof. But, an attacker who successfully identifies the decryption process, and in particular who is able to identify which added rounds are “fake,” can bypass the above added fake rounds protection by deleting these added rounds. This embodiment includes a countermeasure to ensure that all the rounds, including the fake ones, must be used and not bypassed.

Each round is conventionally associated with its subkey kᵢ. In order to make sure that all the rounds are used in the decryption process, compute a value v=I(k′₁, k_{N-1}) where N is the total number of rounds that are executed, and I is a function that mixes all its input values, and replaces the last round subkey which is k_{N} by a new subkey for the last round k′_{N}=k_{N} XOR v where XOR is the Boolean exclusive OR operation.

The real subkeys are thereby mixed in with the fake round subkeys. For example, attacks often try to determine the first or last round subkeys. Replacing these with the fake subkeys enhances security. The mixing function I is in mathematical terms a surjective function that does not lose mathematical entropy if all its inputs except one are fixed. It may be a cryptographic hash function. The general required property is that one cannot guess the value of function I without knowing all its input values.

Therefore, the conventional last round;

SingleDecRound(State, k, NUMBER_OF_ROUNDS−1)

is replaced by:

SingleDecRound(State, k′_{N} XOR v)

Note that this improvement is most meaningful when the main cipher key k is expanded into its subkeys kᵢ, as is conventional.

In the case of the AES cipher, this is particularly easy to implement since in AES the last operation is an Add Round Key, which computes State XOR k_{N}. This embodiment replaces this last round with State XOR k′_{N} XOR v. Note that another logical or arithmetic operation than the exclusive OR may be used here, or more subkeys may be involved, etc. So several variations of this embodiment are possible.

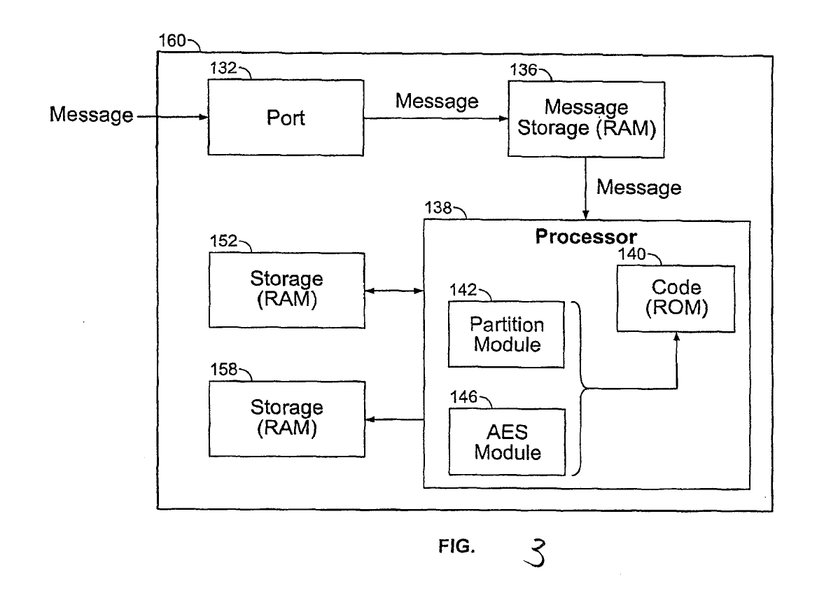

FIG. 3 shows in a block diagram relevant portions of a computing device (system) 160 in accordance with the invention which carries out the cryptographic processes as described above. This is, e.g., a server platform, computer, mobile telephone, Smart Phone, personal digital assistant or similar device, or part of such a device and includes conventional hardware components executing in one embodiment software (computer code) which carries out the above examples. This code may be, e.g., in the C or C++ computer language or its functionality may be expressed in the form of firmware or hardware logic; writing such code or designing such logic would be routine in light of the above examples and logical expressions. Of course, the above examples are not limiting. Only relevant portions of this apparatus are shown for simplicity. Essentially a similar apparatus encrypts the message, and may indeed be part of the same platform.

The computer code is conventionally stored in code memory (computer readable storage medium) 140 (as object code or source code) associated with conventional processor 138 for execution by processor 138. The incoming ciphertext (or plaintext) message (in digital form) is received at port 132 and stored in computer readable storage (memory 136 where it is coupled to processor 138. Processor 138 conventionally then partitions the message into suitable sized blocks at partitioning module 142. Another software (code) module in processor 138 is the decryption (or encryption) module 146 which carries out the decryption or encryption functions as set forth above including the above described modifications to the base cipher, with its associated computer readable storage (memory) 152.

Also coupled to processor 138 is a computer readable storage (memory) 158 for the resulting decrypted plaintext (or encrypted ciphertext) message. Storage locations 136, 140, 152, 158 may be in one or several conventional physical memory devices (such as semiconductor RAM or its variants or a hard disk drive). Electric signals conventionally are carried between the various elements of FIG. 6. Not shown in FIG. 3 is any subsequent conventional use of the resulting plaintext or ciphertext stored in storage 145.

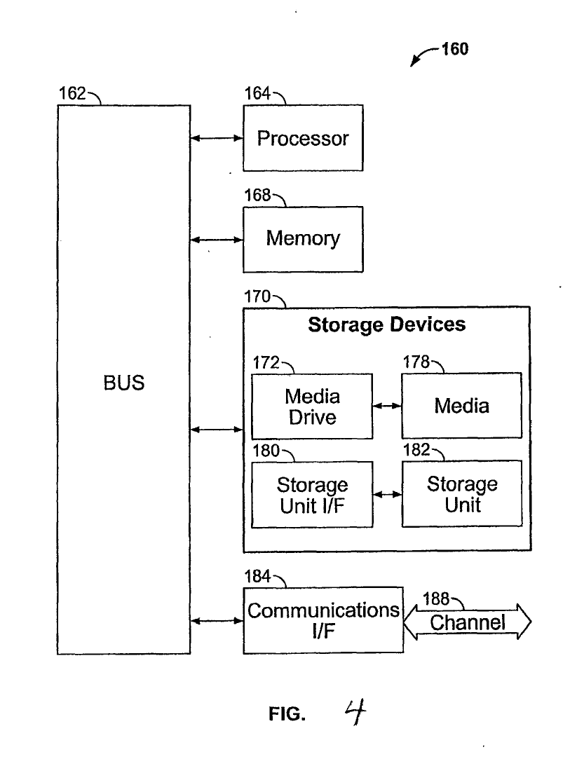

FIG. 4 illustrates detail of a typical and conventional embodiment of computing system 160 that may be employed to implement processing functionality in embodiments of the invention as indicated in FIG. 3 and includes corresponding elements. Computing systems of this type may be used in a computer server or user (client) computer or other computing device, for example. Those skilled in the relevant art will also recognize how to implement embodiments of the invention using other computer systems or architectures. Computing system 160 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 160 can include one or more processors, such as a processor 164 (equivalent to processor 138 in FIG. 2). Processor 164 can be implemented using a general or special purpose processing engine such as, for example, a microprocessor, microcontroller or other control logic. In this example, processor 164 is connected to a bus 162 or other communications medium.

Computing system 160 can also include a main memory 168 (equivalent of memories 136, 140, 152, and 158), such as random access memory (RAM) or other dynamic memory, for storing information and instructions to be executed by processor 164. Main memory 168 also may be used for storing temporary variables or other intermediate information during execution of instructions to be executed by processor 164. Computing system 160 may likewise include a read only memory (ROM) or other static storage device coupled to bus 162 for storing static information and instructions for processor 164.

Computing system 160 may also include information storage system 170, which may include, for example, a media drive 162 and a removable storage interface 180. The media drive 172 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 178 may include, for example, a hard disk, floppy disk, magnetic tape, optical disk, CD or DVD, or other fixed or removable medium that is read by and written to by media drive 72. As these examples illustrate, the storage media 178 may include a computer-readable storage medium having stored therein particular computer software or data.

In alternative embodiments, information storage system 170 may include other similar components for allowing computer programs or other instructions or data to be loaded into computing system 160. Such components may include, for example, a removable storage unit 182 and an interface 180, such as a program cartridge and cartridge interface, a removable memory (for example, a flash memory or other removable memory module) and memory slot, and other removable storage units 182 and interfaces 180 that allow software and data to be transferred from the removable storage unit 178 to computing system 160.

Computing system 160 can also include a communications interface 184 (equivalent to part 132 in FIG. 3). Communications interface 184 can be used to allow software and data to be transferred between computing system 160 and external devices. Examples of communications interface 184 can include a modem, a network interface (such as an Ethernet or other network interface card (NIC)), a communications port (such as for example, a USB port), a PCMCIA slot and card, etc. Software and data transferred via communications interface 184 are in the form of signals which can be electronic, electromagnetic, optical or other signals capable of being received by communications interface 184. These signals are provided to communications interface 184 via a channel 188. This channel 188 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 168, storage device 178, or storage unit 182. These and other forms of computer-readable media may store one or more instructions for use by processor 164, to cause the processor to perform specified operations. Such instructions, generally referred to as “computer program code” (which may be grouped in the form of computer programs or other groupings), when executed, enable the computing system 160 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 160 using, for example, removable storage drive 174, drive 172 or communications interface 184. The control logic (in this example, software instructions or computer program code), when executed by the processor 164, causes the processor 164 to perform the functions of embodiments of the invention as described herein.

This disclosure is illustrative and not limiting. Further modifications will be apparent to these skilled in the art in light of this disclosure and are intended to fall within the scope of the appended claims.

We claim:

1. A method of performing on a message a cryptographic process which is a modified version of a standard cipher which includes a predetermined number of rounds, each round having an associated round key, each round including a plurality of cipher operations, comprising the acts of:
receiving the message at a port;
storing the message in a first computer readable storage medium coupled to the port;
at a processor coupled to the first computer readable memory, applying the plurality of cipher operations for all of the rounds sequentially to the message thereby generating a state for each operation;
wherein the cryptographic process includes at least one additional round over the predetermined number, the additional rounds being appended to the last of the predetermined number of rounds; and
storing each state in a second computer readable medium coupled to the processor.

2. The method of claim 1, wherein the additional rounds use a key which is different from that used by the predetermined number of rounds.

3. The method of claim 1, wherein the cryptographic process is a block cipher.

4. The method of claim 1, wherein the cryptographic process is encryption or decryption and the message is respectively a cleartext or a ciphertext, and wherein for encryption the corresponding decryption includes the same number of additional rounds, and vice versa.

5. The method of claim 4, wherein the cryptographic process includes block chaining, and wherein the predetermined number of rounds is performed in a first chaining, and the additional rounds in a second chaining.

6. The method of claim 5, wherein the block chaining is Cipher Block Chaining mode.

7. The method of claim 1, wherein each of the predetermined number of rounds further includes at least three round key operations, a mix column operation, and a shift row operation, or an inverse thereof.

8. The method of claim 2, wherein the cipher is the AES cipher.

9. The method of claim 1, wherein the cryptographic process is preformed at a client or a server.

10. The method of claim 10, further comprising recovering the message from a final state, by applying a complement of the cryptographic process to the final state.

11. A computer readable medium storing computer code for carrying out the method of claim 1.

12. A computing apparatus programmed to carry out the method of claim 1.

13. An apparatus for performing on a message a cryptographic process which is a modified version of a standard cipher which includes a plurality of rounds, each round having an associated round key, each round including a plurality of cipher operations, comprising:
a port adapted for receiving the message;
a first computer readable storage coupled to the port and adapted to store the received message;
a processor coupled to the first computer readable memory and which applies the plurality of cipher operations for all of the rounds sequentially to the message, thereby generating a state for each operation;
wherein the cryptographic process includes at least one additional round over the predetermined number, the additional rounds being appended to the last of the predetermined number of rounds; and
a second computer readable storage coupled to the processor and adapted to store each state value.

14. A method of performing on a message a cryptographic process which is a modified version of a standard cipher which includes a predetermined number of rounds, each round having an associated key, each round including a plurality of cipher operations, comprising:
receiving the message at a port;
storing the message in a first computer readable storage medium coupled to the port;
at a processor coupled to the port, applying the plurality of cipher operations for all of the rounds sequentially to the message thereby generating a state for each operation;
wherein the cryptographic process includes at least one additional pair of encryption and decryption rounds, wherein each pair outputs a state equal to its input state; and
storing each state in a second computer readable medium.

15. The method of claim 14, wherein the key for the additional pair of rounds is independent of that of any of the predetermined number of rounds.

16. The method of claim 14, wherein the process is encryption or decryption.

17. The method of claim 14, wherein there are at least two additional pairs, arranged in any order of encryption or decryption.

18. The method of claim 14, further including an integrity verification comprising the acts of:
computing a verification value from the keys associated with each of the predetermined number of rounds except for the last of the predetermined number of rounds; and
modifying the key associated with the last round by logically or mathematically combining it with the verification value.

19. Apparatus for performing on a message a cryptographic process which is a modified version of a standard cipher which includes a predetermined number of rounds, each round having an associated key, each round including a plurality of cipher operations, comprising:
a port adapted for receiving the message;
a first computer readable storage medium coupled to the port and adapted to store the message;
a processor coupled to the first storage medium and which applies the plurality of cipher operations for all of the rounds sequentially to the message thereby generating a state for each operation;
wherein the cryptographic process includes at least one additional pair of encryption and decryption rounds, wherein each pair outputs a state equal to its input state; and
a second computer readable medium coupled to the processor and adapted to store the state.
